(19) United States
(12) Patent Application Publication
(10) Pub. No.: US 2025/0167345 A1
(43) Pub. Date: May 22, 2025

(54) TEMPERATURE CONTROL PLATE AND BATTERY CELL ARRANGEMENT

(71) Applicant: MAHLE International GmbH, Stuttgart (DE)

(72) Inventors: Simon Hund, Stuttgart (DE); Jonathan Babitsch, Egenhausen (DE)

(21) Appl. No.: 18/957,258

(22) Filed: Nov. 22, 2024

(30) Foreign Application Priority Data
Nov. 22, 2023 (DE) 102023211655.3

(51) Int. Cl. H01M 10/6557; H01M 10/653; H01M 10/6555; H01M 10/658

(52) U.S. Cl. CPC H01M 10/6557; H01M 10/653; H01M 10/6555; H01M 10/658

(57) ABSTRACT

A temperature-control plate includes a plate-shaped base body that extends in a direction of extension and has a rectangular geometry in a cross section perpendicular to the direction of extension, with two opposing first sides each having a first dimension and two opposing second sides each having a second dimension. The first dimension is greater than the second dimension. The body includes at least one first opening associated with a first temperature-control agent channel and at least one second opening associated with a second temperature-control agent channel. The base body further includes at least one third opening. The at least one third opening is arranged between the at least one first opening and the at least one second opening. The at least one third opening is a thermal insulation structure between the first temperature-control agent channel and the second temperature-control agent channel.

### CROSS REFERENCE TO RELATED APPLICATION

This application claims priority to German Patent Application No. DE102023211655.3, filed on Nov. 22, 2023, the contents of which is hereby incorporated by reference in its entirety.

### TECHNICAL FIELD

The present invention relates to a temperature-control plate, in particular for controlling the temperature of an electric battery of an electric vehicle. The invention also relates to a battery cell arrangement, in particular for an electric vehicle, with at least one such temperature-control plate.

### BACKGROUND

In conventional temperature-control plates, channels through which a temperature-control agent can flow—also referred to below as “temperature-control agent channels”—are provided. Often, such temperature-control plates are designed for so-called intercell temperature control or intercell cooling of electric batteries, which comprise at least two separate battery cells, the temperatures of which must be controlled individually during operation. In the case of intercell temperature control, the temperature-control plate is sandwiched between two battery cells to be temperature-controlled, so that heat transfer can take place between the temperature-control agent flowing through the temperature-control plate and the two battery cells to be temperature-controlled.

However, the problem with such a configuration is that if one of the two battery cells undergoes a thermal burst—also known to experts as “thermal runaway”—there is a risk that the comparatively large amount of heat released within a short period of time may reach the other battery cell via the temperature-control plate due to the thermal coupling of the temperature-control plate to both battery cells. This can cause overheating or even damage to this other battery cell. In extreme cases, the heat input into the other battery cell can also trigger an unwanted thermal burst in that cell.

This effect proves to be particularly disadvantageous if, as is common in electric batteries for motor vehicles, a number of battery cells and temperature-control plates are stacked alternately on top of each other. In this case, there is a risk of a chain reaction in which the thermal bursting of a single battery cell can lead to the successive thermal bursting of two or more neighboring battery cells.

### SUMMARY

It is therefore one of the objectives of the present invention to create an improved design for such a temperature-control plate, in particular for the intercell temperature control, in which the aforementioned problem is largely, preferably even completely, eliminated.

This object is achieved by the scope of the independent claims. Preferred embodiments are the subject of the dependent claims.

The basic idea of the invention is therefore to equip a temperature-control plate with a first temperature-control agent channel through which a temperature-control agent can flow, for controlling the temperature of a first of a total of two battery cells, and with a second temperature-control agent channel through which a temperature-control agent can also flow, for controlling the temperature of a second of the two battery cells. According to the invention, it is proposed that between the first and second temperature-control agent channels, which may be realized as (first and second, respectively) openings formed in the temperature-control plate, a further opening-hereinafter referred to as “third opening”—is provided, which acts as thermal insulation between the first and second temperature-control agent channels or first and second openings. This type of thermal insulation prevents, or at least makes it more difficult, for heat to pass from a first of the two battery cells to be temperature-controlled to a second of the two battery cells to be temperature-controlled via the temperature-control plate. This heat would be dissipated by the temperature-control agent conducted through the first temperature-control agent channel in the event of a thermal bursting. This thermal insulation also prevents, or at least makes it more difficult, for heat to pass from the second of the two battery cells to be temperature-controlled to the first of the two battery cells to be temperature-controlled via the temperature-control plate. This heat is to be dissipated by the temperature-control agent conducted through the second temperature-control agent channel in the event of a thermal bursting.

Since the thermal insulation in question is an opening provided in the temperature-control plate or in a base body of the temperature-control plate, it communicates fluidically with the environment of the temperature-control plate. This means that the thermal insulation in question is achieved by the air typically present in the vicinity of the temperature-control plate. It is therefore understood that, due to the thermal conductivity of the air present in the third opening, which is not equal to zero, the said third opening cannot produce an ideal, i.e., complete, thermal insulation, which would correspond to a zero value of the thermal conductivity. Rather, the thermal insulation discussed here, or the third opening, achieves a significant reduction in thermal conductivity compared to the material of the base body-typically a metal or another material with high thermal conductivity. The temperature-control plate according to the invention helps to prevent one of the two battery cells from causing the other battery cell to thermally burst. But even in a nominal operation, the temperature-control plate according to the invention counteracts unwanted heat transfer from one of the two battery cells to the other battery cell. This also ensures better thermal management and thus improved control of the temperature of the battery cells in nominal, i.e., error-free, operation.

In accordance with the inventive concept explained above, a temperature-control plate according to the invention comprises a plate-shaped base body that extends in a direction of extension and, in a cross section perpendicular to the direction of extension, has a substantially rectangular geometry with two opposing broad sides and two opposing narrow sides.

The term “essentially” can preferably be understood to mean that the geometry of the base body deviates from an ideal rectangle. In particular, it is conceivable that the two opposing broad sides and/or narrow sides are not exactly parallel to each other, but at an angle of up to 2°, preferably up to 1°. It is also conceivable that the narrow and/or broad sides in particular have locally extending contours that cause the narrow and broad sides to deviate from a completely straight line. Such contours may be caused, for example, by locally formed projections or indentations in the base body.

At least one first and at least one second opening, each extending along the direction of extension and through which a temperature-control agent can flow, are formed in the base body of the temperature-control plate according to the invention. The at least one first opening forms a first temperature-control agent channel through which a temperature-control agent can flow. The at least one second opening forms a second temperature-control agent channel through which the temperature-control agent can flow. The temperature-control agent channels each opening into opposite end faces of the base body in the direction of extension. In the cross-section perpendicular to the direction of extension, the at least one first opening is arranged between a first of the two broad sides and the at least one second opening. Accordingly, the at least one second opening is arranged between a second of the two broad sides and the at least one first opening. According to the invention, in order to form a thermal insulation between the at least one first opening and the at least one second opening, at least one third opening is formed in the base body, which extends between the two end faces of the base body, likewise along the direction of extension, and is arranged in the cross-section perpendicular to the direction of extension between the at least one first opening and the at least one second opening. By means of the at least one third opening, the temperature-control plate is divided into a first temperature control zone, in which the at least one first opening is arranged, and a second temperature control zone, in which the at least one second opening is arranged. The at least one third opening provides improved thermal insulation between the two temperature control zones.

The at least one third opening can be designed as a (passage) slot. Using this geometry, the temperature-control plate can be divided into the first and second temperature control zones with particular thermal effectiveness. The two temperature control zones are particularly well insulated from each other by means of a slot of suitable dimensions, as described above. Thus, the first temperature control zone can be arranged to control the temperature of a first battery cell and the second temperature control zone to control the temperature of a second battery cell, if the temperature-control plate is arranged in a sandwich-like manner between these two battery cells.

According to a favorable further development, the slot in the cross-section perpendicular to the direction of extension extends parallel to at least one of the two broad sides. This allows one of the two battery cells to be temperature-controlled to be arranged on one of the two broad sides, so that the desired thermal insulation of the two broad sides and thus of the two battery cells from one another is achieved by means of the slot.

In a preferred embodiment, at least two third openings or slots are arranged at a distance from each other in the cross-section perpendicular to the direction of extension along a direction parallel to at least one of the two broad sides. Compared to a continuous formation of a single slot, this embodiment achieves increased mechanical stability of the base body or the temperature-control plate due to the slot interruption formed between the at least two slots.

According to a favorable training, the temperature-control plate can be designed in one piece. This embodiment is particularly easy to manufacture and is therefore particularly cost-effective to produce.

According to another advantageous further development, the temperature-control plate can also be designed in two parts and comprise a plate top part and a plate bottom part that are detachably or non-detachably attached to one another. In this advanced training, at least one third opening or thermal insulation is arranged between the plate top part and plate bottom part. Such a two-part design of the temperature-control plate or the base body simplifies the production of the invention-essential third opening for the formation of the thermal insulation.

In a further preferred embodiment, the at least one third opening is at least partially delimited by an outer side of the plate top part facing the plate bottom part and by an outer side of the plate bottom part facing the plate top part. This embodiment is also characterized by a particularly simple constructive structure.

According to another advantageous further development, the plate top part and the plate bottom part can be connected to each other by means of a form-fitting connection. This ensures a high mechanical stability of the two-part temperature-control plate-even in the event of thermal bursting.

The plate top part and plate bottom part can be firmly bonded to one another using an adhesive. This further increases the strength of the two-part temperature-control plate.

According to a further advantageous development, at least two first openings are provided in the base body of the temperature-control plate according to the invention, which are arranged at a distance from one another in the cross section perpendicular to the direction of extension along the direction running parallel to at least one of the two broad sides. Alternatively or in addition, in the case of this further development of the invention-related temperature-control plate, at least two second openings are provided, which are arranged at a distance from each other in the cross-section perpendicular to the direction of extension along a direction running parallel to at least one of the two broad sides. In this further development, the number of first and second temperature-control agent channels can be adapted to the specific application—in particular with regard to the desired heating or cooling capacity to be achieved by means of the heating or cooling system.

At least one first opening and/or at least one second opening may have the geometry of an elongated hole. It is particularly easy to create openings with the geometry of an elongated hole, meaning that this variant offers significant cost advantages in the production of the temperature-control plate.

In another preferred embodiment, the material of the temperature-control plate can be a metal, in particular aluminum. Since metals have a high thermal conductivity, this enables good thermal coupling of battery cells to be temperature-controlled using the temperature-control plate. Alternatively or additionally, in this embodiment, the thermal conductivity of the material of the temperature-control plate or the base body can be 30 W/mK and 430 W/mK.

The invention also relates to a battery cell arrangement, in particular for an electric vehicle, with a rechargeable electric battery comprising at least two battery cells, preferably arranged at a distance from one another along a stacking direction. The battery cell arrangement according to the invention also has a temperature-control plate as presented above, which is arranged, preferably in a sandwich-like manner, between the at least two battery cells, so that heat can be transferred between the temperature-control agent, which is guided by the temperature-control plate, and the battery cells. Thus, the temperature-control plate can be used to control the temperature of the two battery cells by supplying or removing heat. Preferably, the temperature-control plate should be in flat contact with the two battery cells. The temperature control of a first of two battery cells can preferably be carried out with the aid of the temperature-control agent guided through the at least one first temperature-control agent channel, and the temperature control of a second of these two battery cells can preferably be carried out with the aid of the temperature-control agent guided through the at least one second temperature-control agent channel.

In a further embodiment of the battery cell arrangement according to the invention, this can comprise a plurality of battery cells, i.e., at least three battery cells, and at least two temperature-control plates, wherein the battery cells and the temperature-control plates are stacked alternately along a stacking direction. The temperature of the battery cells and the temperature-control plates thus form a so-called battery cell stack, and the individual battery cells can be effectively controlled with the aid of the individual temperature-control plates.

Further important features and advantages of the invention are apparent from the sub-claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWING

The following is shown-schematically in each case—in the images below:

FIG. 1 in isometric view, an example of a one-piece temperature-control plate according to the invention.

FIG. 2 the temperature-control plate of FIG. 1 in cross-section,

FIG. 3 a variant of the example of FIG. 1, in which the temperature-control plate is designed in two parts,

FIG. 4 an example of a battery cell arrangement according to the invention, with the temperature-control plate of FIGS. 1 and 2 in a side view,

FIG. 5 a variant of the example in FIG. 4.

### DETAILED DESCRIPTION

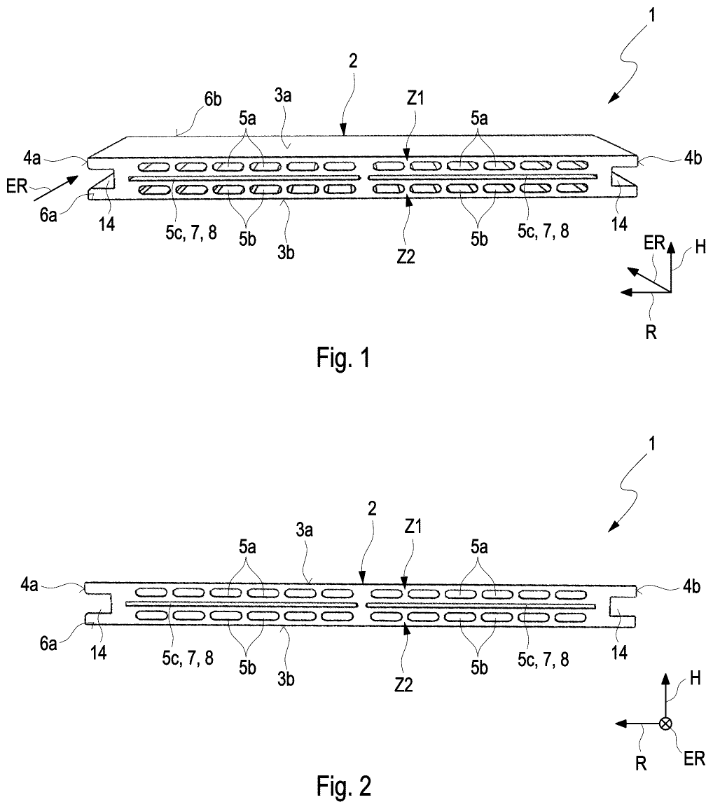

FIG. 1 shows an example of a temperature-control plate 1 according to the invention in an isometric view, FIG. 2 shows a cross-section. In the example of FIGS. 1 and 2, the temperature-control plate 1 is designed in one piece. The material of the temperature-control plate 1 or its base body can be a metal, for example aluminum. The preferred thermal conductivity of the material of the temperature-control plate and the base body is 30 W/mK and 430 W/mK.

According to FIGS. 1 and 2, the temperature-control plate 1 comprises a plate-shaped base body 2 extending along a direction of extension ER, which, in the cross-section perpendicular to the direction of extension ER shown in FIG. 2, has a rectangular geometry with two opposing broad sides 3a, 3b and with two opposing narrow sides 4a, 4b.

In the base body 2, several first openings 5a are formed, each extending along the direction of extension ER and through which a temperature-control agent can flow. In addition, a plurality of second openings 5b, through which a temperature-control agent can flow and which also extend along the direction of extension ER, are formed in the base body 2. The first openings 5a each form a first temperature-control agent channel through which a temperature-control agent can flow. The second openings 5b each form a second temperature-control agent channel through which the temperature-control agent can flow. The first openings 5a are arranged successively at a distance from one another in the cross-section shown in FIG. 2, perpendicular to the direction of extension ER, along a direction R parallel to the two broad sides 3a, 3b. The second openings 5b are also arranged successively at a distance from one another in the cross-section shown in FIG. 2, perpendicular to the direction of extension ER, along the direction R. Furthermore, in the cross-section shown perpendicular to the direction of extension ER, the first openings 5a are arranged along a vertical direction H perpendicular to the direction of extension ER between a first 3a of the two broad sides 3a, 3b and the second openings 5b. Accordingly, the second openings 5b are arranged along the vertical direction H between a second 3b of the two broad sides 3a, 3b and the first openings 5a.

Both the first openings 5a and the second openings 5b lead in each case into two opposing end faces 6a, 6b of the base body 2 with respect to the direction of extension ER. The first and second openings 5a, 5b can each have the geometry of an elongated hole 11.

As FIG. 2 also illustrates, in the cross-section shown there, perpendicular to the direction of extension ER, between the first openings 5a and the second openings 5b along the direction R, two third openings 5c, each in the form of a slot 7 extending along the direction R, are arranged consecutively and at a distance from one another. By means of the third openings 5c, the temperature-control plate 1 and the base body 2, in particular in the cross-section shown in FIG. 2, are subdivided into a first temperature control zone Z1, in which the first openings 5a are arranged, and into a second temperature control zone Z2, in which the second openings 5b are arranged. The third openings 5c act as thermal insulation 8 between the two temperature control zones Z1, Z2 and extend, like the first and second openings 5a, 5b, between the two end faces 6a, 6b (see FIG. 1), into which they open, like the first and second openings 5a, 5b.

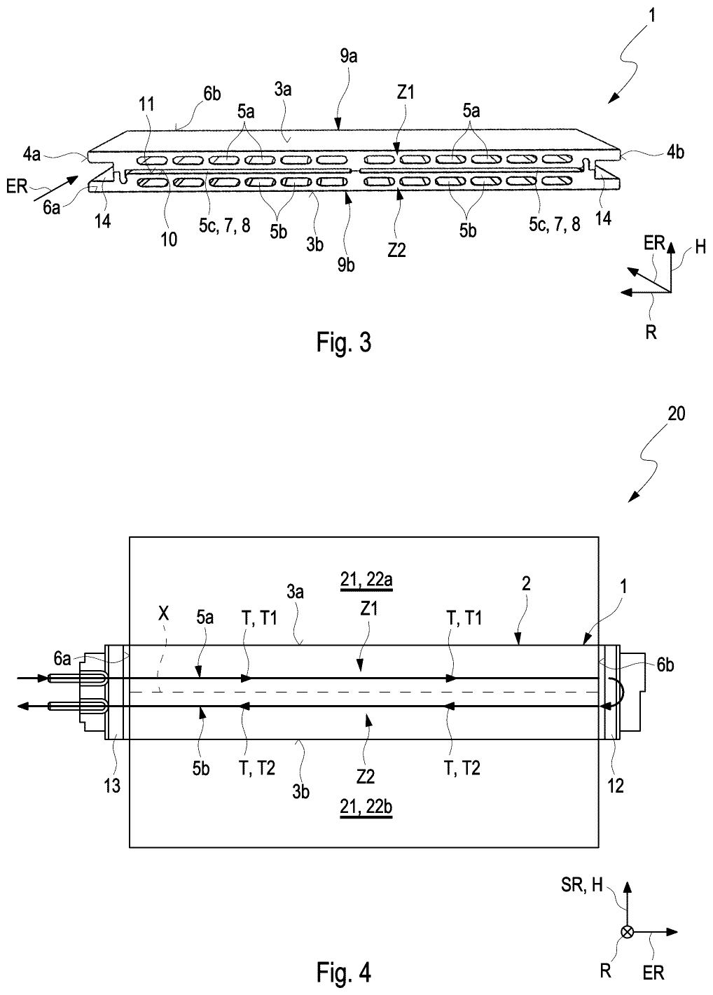

FIG. 3 shows a variant of the example of FIGS. 1 and 2. In the example shown in FIG. 3, the temperature-control plate 1 is designed in two parts, in contrast to the example shown in FIG. 1, and comprises a plate top part 9a and a plate bottom part 9b that are attached to each other. Furthermore, the two third openings 5c and thus the thermal insulation 8 are arranged between the plate top part 9a and the plate bottom part 9b. The terms “top” and “bottom” refer to a possible position of use of the temperature-control plate 1, taking into account the direction of gravity. This means that the plate bottom part 9b is arranged below the plate top part 9a, preferably in the direction of gravity (not shown in the figures). It is understood that other positions of use are also possible in variants, in particular those in which the plate top part 9a—despite seemingly contradictory labeling—is arranged below the plate bottom part 9b with respect to the direction of gravity.

In the example of FIG. 3, the two third openings 5c and slots 7 are orthogonal to the direction R, i.e., along the vertical direction H, in each case bounded by an outer side 10 of the plate top part 9a facing the plate bottom part 9b and by an outer side 11 of the plate bottom part 9b facing the plate top part 9a. The two outer sides 10, 11 lie opposite each other along the vertical direction H, perpendicular to the direction R and also perpendicular to the direction of extension ER. The plate top part 9a and the plate bottom part 9b can be connected to each other as shown in FIG. 3 by means of a form-fitting connection, in particular a detachable connection. However, it is also conceivable that the plate top part 9a and the plate bottom part 9b are firmly connected to each other by means of an adhesive bond—as an alternative or in addition to the aforementioned positive fit.

As can be seen from FIGS. 1 through 3—in particular FIG. 2—a recess 14, which extends along the direction of extension ER, can be formed on the two narrow sides 4a, 4b, by means of which the temperature-control plate 1 can be attached to an external component, in particular of a motor vehicle.

FIG. 4 shows the temperature-control plate 1 of FIGS. 1 and 2 in a side view. In this side view, the direction R is perpendicular to the paper plane.

FIG. 4 illustrates the flow of the temperature-control agent T through the first and second openings 5a, 5b, which each form a temperature-control agent channel.

As can be seen in FIG. 4, the temperature-control medium T, after entering the first openings 5a, flows over the first end face 6a along the direction of extension ER through the base body 2 and exits the base body 2 at the second end face 6b.

As FIG. 4 illustrates, a temperature-control agent deflector 12 can be arranged on the second end face 6b, via which the temperature-control agent T is introduced into the second openings 5b after exiting the first openings 5a and thus flows through the base body 2 in the opposite direction to the direction of extension ER until it exits the base body 2 again at the first end face 6a.

To introduce the temperature-control agent T into the first openings 5a and to discharge the temperature-control agent T from the second openings 5b, a correspondingly designed connection piece 13 can be provided on the first end face 6a.

FIG. 4 also shows how the temperature-control plate 1 can be used in an inventive battery cell arrangement 20 for an electric vehicle. A battery cell arrangement 20 of this kind comprises a plurality of battery cells 22a, 22b and a plurality of temperature-control plates 1, which are alternately stacked along a stacking direction SR. For the sake of simplicity, FIG. 4 shows only two such battery cells 33a, 22b and a single temperature-control plate 1, which is sandwiched between the two battery cells 22a, 22b so that heat can be transferred between the temperature-control agent T passing through the temperature-control plate 1 and the battery cells 22a, 22b.

As can be seen from FIG. 4, each of the two battery cells 22a, 22b is in flat contact with the temperature-control plate 1, in particular with one of the broad sides 3a, 3b defined in the cross-section of FIG. 2. This ensures that the two battery cells 22a, 22b are well thermally coupled to the temperature-control plate 1. The subdivision of the temperature-control plate 2 and its base body 2 into the first and second temperature control zones Z1 and Z2, effected by means of the third openings 5c (not shown in FIG. 4)—the course of this subdivision is indicated in FIG. 4 by a dashed line marked with the reference sign X—has the consequence that the first battery cell 22a is primarily thermally coupled to the temperature-control agent T, T1 flowing through the first openings 5a and the second battery cell 22b is primarily thermally coupled to the temperature-control agent T2 flowing through the second openings 5.

The exemplary embodiment of FIG. 4 explained above can also be combined with that of FIG. 3.

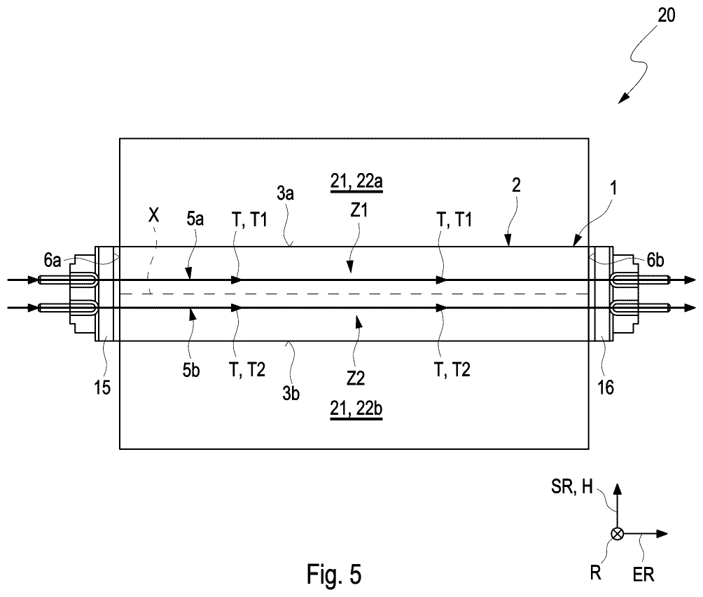

FIG. 5 shows a variant of the example in FIG. 4, in which deflector 13 is omitted. Thus, there is no deflection of the temperature-control agent T. In this example, the temperature-control agent T flows through both the first openings 5a and
the second openings 5b along the direction of extension ER. The temperature-control agent T1 flowing through the first openings 5a is additionally labeled T1 in FIG. 5, and the temperature-control agent T flowing through the second openings 5a is additionally labeled T2.

To introduce the temperature-control agent T into the first openings 5a and into the second openings 5b, a correspondingly designed connection piece 15 can be provided on the first end face 6a. To discharge the temperature-control agent T, T1, T2 into the first and second openings 5a, 5b, a correspondingly designed connection piece 16 can be provided on the second end face 6b. The two connection pieces 15, 16 can be designed as non-variable parts 15, 16.

What is claimed is:

1. A temperature-control plate comprising:
a plate-shaped base body that extends along a direction of extension and has a rectangular geometry in a cross-section perpendicular to the direction of extension with two opposing first sides each having a first dimension and two opposing second sides each having a second dimension, the first dimension greater than the second dimension,
wherein the base body includes at least one first opening associated with a first temperature-control channel and at least one second opening associated with a second temperature-control channel, allowing a temperature-control agent flow through both channels, and the first temperature-control channel and the second temperature-control channel extend along the direction of extension and the first temperature-control channel and the second temperature-control channel open into mutually opposite end faces of the base body with respect to the direction of extension,
wherein the at least one first opening is arranged between a first of the two first sides and the at least one second opening, the at least one second opening is arranged between a second of the two first sides and the at least one first opening, and
wherein the base body further includes at least one third opening acting as a thermal insulation structure, which also extends along the direction of extension between the two end faces and is arranged between the at least one first opening and the at least one second opening.

2. The temperature-control plate according to claim 1, wherein a shape of the at least one third opening is a slot.

3. The temperature-control plate according to claim 2, wherein the slot extends in the cross-section perpendicular to the direction of extension parallel to at least one of the two first sides.

4. The temperature-control plate according to claim 2, wherein the at least one third opening includes at least two third openings or slots that are arranged at a distance from one another in the cross-section perpendicular to the direction of extension along a direction running parallel to at least one of the two first sides.

5. The temperature-control plate according to claim 1, wherein the temperature-control plate is made of one piece.

6. The temperature-control plate according to claim 1,
wherein the temperature-control plate is made of two parts that are a plate top part and a plate bottom part attached to each other, and
wherein the at least one third opening or the thermal insulation structure is arranged between the plate top part and the plate bottom part.

7. The temperature-control plate according to claim 6, wherein the at least one third opening is at least partially delimited by an outer side of the plate top part facing the plate bottom part and by an outer side of the plate bottom part facing the plate top part.

8. The temperature-control plate according to claim 6, wherein the plate top part and the plate bottom part are connected to each other by means of a form-fitting connection.

9. The temperature-control plate according to claim 6, wherein the plate top part and the plate bottom part are firmly connected to one another by means of an adhesive bond.

10. The temperature-control plate according to claim 1,
wherein the at least one first opening includes at least two first openings, which are arranged at a distance from each other in the cross-section perpendicular to the direction of extension along a direction running parallel to at least one of the two first sides, and
wherein the at least one second opening includes at least two second openings, which are arranged at a distance from one another in the cross-section perpendicular to the direction of extension along the direction running parallel to at least one of the two first sides.

11. The temperature-control plate according to claim 1, wherein at least a first opening and/or at least a second opening has a geometry of an elongated hole.

12. The temperature-control plate according to claim 1, wherein the temperature-control plate is made of a metal.

13. A battery cell arrangement comprising:
a rechargeable electric battery comprising at least two battery cells arranged at a distance from one another along a stacking direction, and
at least one temperature-control plate arranged in a sandwich-like manner, between the two battery cells, so that heat can be transferred between a temperature-control agent guided through the temperature-control plate and the battery cells,
wherein the at least one temperature-control plate comprises:
a plate-shaped base body that extends along a direction of extension and has a rectangular geometry in a cross-section perpendicular to the direction of extension with two opposing first sides each having a first dimension and two opposing second sides each having a second dimension, the first dimension greater than the second dimension,
wherein the base body includes at least one first opening associated with a first temperature-control channel and at least one second opening associated with a second temperature-control channel, allowing the temperature-control agent flow through both channels, and the first temperature-control channel and the second temperature-control channel extend along the direction of extension and the first temperature-control channel and the second temperature-control channel open into mutually opposite end faces of the base body with respect to the direction of extension,
wherein the at least one first opening is arranged between a first of the two first sides and the at least one second opening, the at least one second opening is arranged between a second of the two first sides and the at least one first opening, and
wherein the base body further includes at least one third opening acting as a thermal insulation structure, which also extends along the direction of extension between the two end faces and is arranged between the at least one first opening and the at least one second opening.

14. The temperature-control plate according to claim 7, wherein the plate top part and the plate bottom part are connected to each other by means of a form-fitting connection.

15. The temperature-control plate according to claim 7, wherein the plate top part and the plate bottom part are firmly connected to one another by means of an adhesive bond.

16. The temperature-control plate according to claim 8, wherein the plate top part and the plate bottom part are firmly connected to one another by means of an adhesive bond.

17. The temperature-control plate according to claim 1, wherein the temperature-control plate is made of aluminum.

18. The temperature-control plate according to claim 1, wherein the temperature-control plate is made of a material having a thermal conductivity between 30 W/mK and 430 W/mK.

19. The temperature-control plate according to claim 1, wherein the base body is made of material having a thermal conductivity between 30 W/mK and 430 W/mK.

20. The temperature-control plate according to claim 1,
wherein:
the at least one first opening includes at least two first openings, which are arranged at a distance from each other in the cross-section perpendicular to the direction of extension along a direction running parallel to at least one of the two first sides, or
the at least one second opening includes at least two second openings, which are arranged at a distance from one another in the cross-section perpendicular to the direction of extension along the direction running parallel to at least one of the two first sides.
